(19) United States
(12) Patent Application Publication
(10) Pub. No.: US 2009/0012213 A1
(43) Pub. Date: Jan. 8, 2009

(54) Composite Plastics Material

(75) Inventors: Gerd Schmaucks, Sogne (NO); Jan Olaf Roszinski, Sogne (NO)

Correspondence Address: LUCAS & MERCANTI, LLP, 475 PARK AVENUE SOUTH, 15TH FLOOR, NEW YORK, NY, 10016, US

(73) Assignee: ELKEM AS, Oslo (NO)

(21) Appl. No.: 12/279,118

(22) PCT Filed: Feb. 27, 2006
(86) PCT No.: PCT/NO06/00076

§ 371 Date: Aug. 12, 2008

(30) Foreign Application Priority Data
Feb. 15, 2006 (NO) 20060742

(51) Int. Cl. C08L 97/02; C08K 3/36; C08K 3/10; C08K 3/26; C08K 3/34

(52) U.S. Cl. 524/13; 524/451; 524/437; 524/425; 524/456; 524/493; 524/551; 524/559; 524/583; 524/586

(57) ABSTRACT

A composition for making a composite plastics material, comprising a polymer, wood fibre and microsilica. The microsilica, i.e., silica fume, is added for the purpose of reducing the water absorption while maintaining, or improving, the flame retardancy, mechanical performance and processibility of the material. The intended polymers for the composite materials are polyethylene (PE), polyvinylchloride (PVC), polypropylene (PP) or polyethylene terephthalate (PET). The composites can be shaped through extrusion or heat-moulding.

The present invention relates to a composite plastics material, in particular, a natural organic filler or natural organic fibre-reinforced plastics material. The invention is applicable to thermoset and thermoplastic materials and a proportion of the filler or fibres incorporated may be synthetic. The invention is particularly relevant to thermoplastics reinforced with wood flour or fibres.

Fibre reinforced plastics are widely used in the building industry, in the automotive industry and in several other high performance applications, due to their specific properties such as thermal stability, impact resistance and tensile strength. In recent years, the use of natural fibres, mainly wood flour (or fibres) has been especially popular due to their availability, low price and low density compared to glass fibres. However, these natural fibres also have certain disadvantages, including difficulty in processing (temperature sensitivity), high flammability, lower mechanical properties and most significantly higher water absorption, than for example glass fibres. To be able to replace glass fibres with natural fibres in similar applications, it is therefore necessary to improve the performance of the final article by adding further materials to the composite material.

Flame retardant additives might be required for certain application areas. Fillers such as talc, calcium carbonate or wollastonite, or combinations of these with synthetic fibres (e.g. glass or carbon fibres) might be used to improve the generally inferior mechanical properties, but the incorporation of these materials can lead to other negative effects. One of these disadvantages is the high compound viscosity which leads to reduced processing speed. The optimisation of compound properties and processing behaviour and the performance of the final article made out of these plastics compounds is therefore very difficult.

However, the major problem with plastic materials containing natural organic fillers or fibres, particularly wood fibres, is water absorption. When the plastic material is subjected to water or humidity, the material will, due to the content of natural fibre, absorb water and deteriorate.

This problem has previously been addressed in basically two ways:
a) Coating of the natural organic fibres before they are added to the polymer resin. The coating is carried out by treating the fibres with modified polymers called compatibilisers, in order to provide a waterproof coating on the individual fibres or filler particles. This process is very costly and adds to the cost of the finished products.
b) Coating of the finished composite plastics materials with a waterproof coating. This process also adds to the cost of the finished products.

It is an object of the present invention to provide a composite plastics material with improved properties and a composition for making such a material. It is a more specific object to provide a natural filler or natural fibre reinforced plastics material with reduced water absorbency and a composition for making such a material.

According to the invention, there is provided a composition for making composite plastics material, comprising: a polymer, a natural filler and/or a natural fibre, and additionally, microsilica.

The term microsilica used in the specification and claims of this application is particulate amorphous SiO₂ obtained from a process in which silica (quartz) is reduced to SiO-gas and the reduction product is oxidised in vapour phase to form amorphous silica. Microsilica may contain at least 80% by weight silica (SiO₂) and has a specific density of 2.1-2.3 g/cm³ and a surface area of 15-50 mg²/g. The primary particles are substantially spherical and have an average size of about 0.15 μm. Microsilica is preferably obtained as a coproduct in the production of silicon or silicon alloys in electric reduction furnaces. The microsilica is recovered in a conventional manner using baghouse filters or other collection apparatus and may be further processed by removing coarse particles, surface modification and others.

Preferably the microsilica contains more than 90% by weight of SiO₂ and has less than 0.1% by weight of particles having a particle size of more than 45 μm.

The problem of water absorption is solved by the present invention by adding microsilica to the polymer. Even though it is known that other types of amorphous silicas like precipitated silica and pyrogenic silica, are porous and absorb water, it has surprisingly been found that the addition of microsilica strongly reduces water absorption in composite plastic materials containing natural fibres.

The polymer may be a thermoset or a thermoplastic. Suitable materials include polyethylene (PE), polyvinylchloride (PVC), polypropylene (PP), polyethylene terephthalate (PET). The natural filler and natural fibre, include fillers and fibres such as wood fibre, wood flour, wood flakes, saw dust, kenaf, flax, hemp and combinations of these, though other fillers may be used, in addition to the above, such as talc, CaCO₃, wollastonite, aluminium trihydrate and combinations of these.

The composition may include additives, such as pigments, stabilisers, lubricants and other conventional additives used in thermoset or thermoplastic polymers.

Preferably, the proportion of natural filler and/or fibre present is 40 to 80 wt %, more preferably 45 to 60%, for example 50 to 60 wt %.

Preferably, the proportion of polymer present is in the range 10 to 60 wt %, more preferably 20 to 50 wt %, for example 30 to 50 wt %.

Preferably, the proportion of microsilica is in the range 3 to 20 wt %, more preferably 5 to 15 wt %, for example 5 to 10 wt %.

In the case of a thermoset polymer, a conventional cross linking agent is used.

It has been found that when the composition according to the invention is used to make a composite material, the material has improved properties.

It has been found possible to reduce the water absorption significantly while still providing extraordinary flame retardancy, and at the same time improve the mechanical performance and processibility of the material. These advantageous effects are due to the presence of the microsilica. Since the use of microsilica strongly reduces the water absorption of the composition, it is not necessary to coat the filler or fibre prior to mixing these with the polymer or to apply a waterproof coating to the finished product and so the resulting composite material will be less costly than current alternatives. In addition it is possible to reduce the proportion of relatively costly polymer.

The invention extends to a method of making a composite material, by heat-extruding a composition as defined, when the polymer is a thermoplastic, or by forming (optionally) the composition and curing the polymer when the polymer is thermosetting or some other form of cross-linking polymer.

The processing conditions will vary greatly, but it has been found that the addition of microsilica does not change the processing of the compounds significantly. Conventional processing equipment and processing conditions can therefore be used.

The invention extends to a composite material made from a composition of the invention.

The invention may be carried into practice in various ways and will now be illustrated in the following non-limiting Examples. In the accompanying drawings,

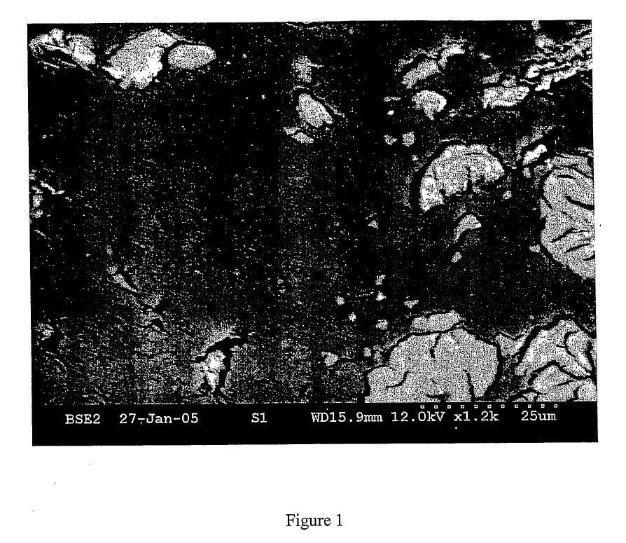

FIG. 1 is an SEM of wood fibre filled high density polyethylene (HDPE);

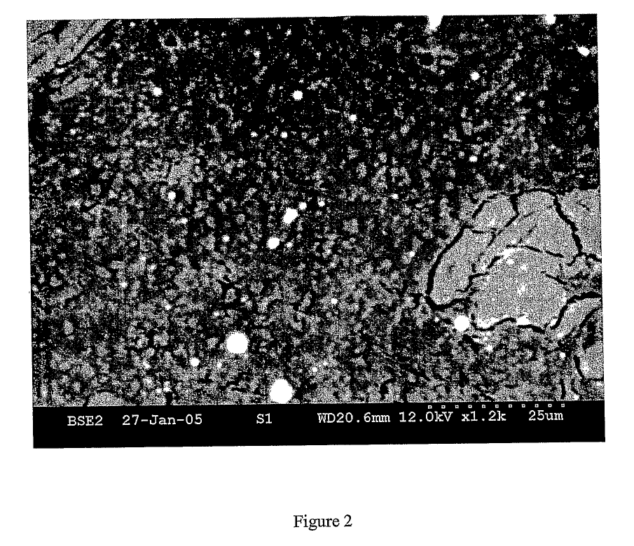

FIG. 2 is an SEM of wood fibre filled HDPE, but including 10 wt % microsilica;

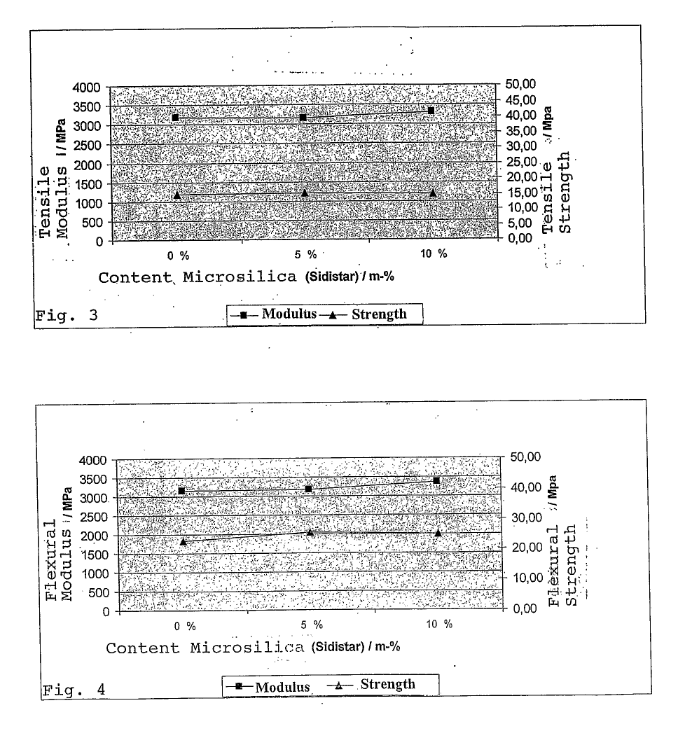

FIG. 3 is a graph showing tensile modulus and tensile strength for composite materials including HDPE, both with and without microsilica;

FIG. 4 is a graph similar to FIG. 3, showing flexural modulus and flexural strength;

### EXAMPLE 1

### Addition of Amorphous Silica to Wood Fibre Filled HDPE

Samples were made up according to the parameters in Table 1.

TABLE 1

| Sample No. | Composition in wt % |
|---|---|
| [5012-05] 0701 | 42% HDPE |
| | 58% maple wood chips |
| | 5% lubricant |
| | 0% microsilica |
| [5012-05] 0702 | 37% HDPE |
| | 58% maple wood chips |
| | 5% lubricant |
| | 5% microsilica |
| [5012-05] 0703 | 32% HDPE |
| | 58% maple wood chips |
| | 5% lubricant |
| | 10% microsilica |

When the mixture is processed, the temperature is such that moisture is released. For that reason, the total weight % differs from 100%.

The HDPE used was AD 60-007 (Exxon)

The microsilica used was SIDISTAR (Elkem)

The lubricant was STRUKTOL (Schill & Seilacher)

The concentration of the fibres and lubricant have been kept constant, the addition of silica therefore reduced the amount of polymer. This means that at 10% silica addition the compound contains only 32% polymer. It was found that the material was processable without difficulty. The extrusion parameters are shown in Table 2.

TABLE 2
Extrusion parameters of wood fibre reinforced HDPE

| | Sample No. | | |
|---|---|---|---|
| | 0701 | 0702 | 0703 |
| Silica content | 0 | 5% | 10% |
| Extruder speed [rpm] | 347 | 349 | 347 |
| Extruder load [% of max] | 26 | 41 | 38 |
| Melt pressure [MPa] | 12.58 | 12.87 | 10.27 |
| Melt temperature [deg C.] | 165.9 | 167.0 | 166.6 |

It is also surprising to notice that at constant extruder speed and melt temperature, the melt pressure decreases with increasing amounts of silica. The increase in extruder load is the result of the energy required to break down the silica agglomerates. Once broken down to spherical primary particles, they improve the flow thus reducing the melt pressure.

Properties relating to tensile strength are shown in Table 3. Testing was carried out in accordance with ISO 527-1, using a constant velocity of 2 mm/min at a temperature of 23° C. Mean values and standard deviations are given for 5 tests per sample. The results are graphically represented in FIG. 3.

TABLE 3

| | | | Tensile | | Elongation at | |
|---|---|---|---|---|---|---|
| | Tensile Modulus | | Strength | | max. Force | |
| | E [MPa] | | σₘ [MPa] | | ε − Fₘₐₓ [%] | |
| Sample No. | x̅ | s | x̅ | s | x̅ | s |
| 701 | 3171.38 | 115.66 | 14.58 | 0.30 | 1.32 | 0.04 |
| 702 | 3165.29 | 290.88 | 15.20 | 0.43 | 1.35 | 0.07 |
| 703 | 3308.74 | 98.30 | 14.73 | 0.40 | 0.85 | 0.04 |

Properties relating to flexural strength of the samples are shown in Table 4. Testing was carried out in accordance with ISO 178, using a constant velocity of 2 mm/min, a temperature of 23° C. and a sample length of 64 mm. Mean values and standard deviations are given for five tests per sample. The results are graphically represented in FIG. 4.

TABLE 4

| | Flexural | | Flexural | | Elongation at | |
|---|---|---|---|---|---|---|
| | Modulus | | Strength | | max. Force | |
| | E [MPa] | | σₘ [MPa] | | ε − Fₘₐₓ [%] | |
| Sample No. | x̅ | s | x̅ | S | x̅ | s |
| 701 | 3153.24 | 223.51 | 22.81 | 0.52 | 2.00 | 0.27 |
| 702 | 3165.96 | 67.70 | 25.62 | 0.66 | 2.32 | 0.17 |
| 703 | 3379.74 | 196.78 | 24.99 | 0.88 | 1.62 | 0.09 |

Properties relating to the Charpy impact strength are shown in Table 5. Testing was carried out in accordance with ISO 179 at 23° C. until complete breakage. Mean values and standard deviations are given for ten tests per sample. The results are graphically represented in FIG. 5.

FIG. 5 is a graph showing Charpy impact strength for composite materials including HDPE, both with an without microsilica;

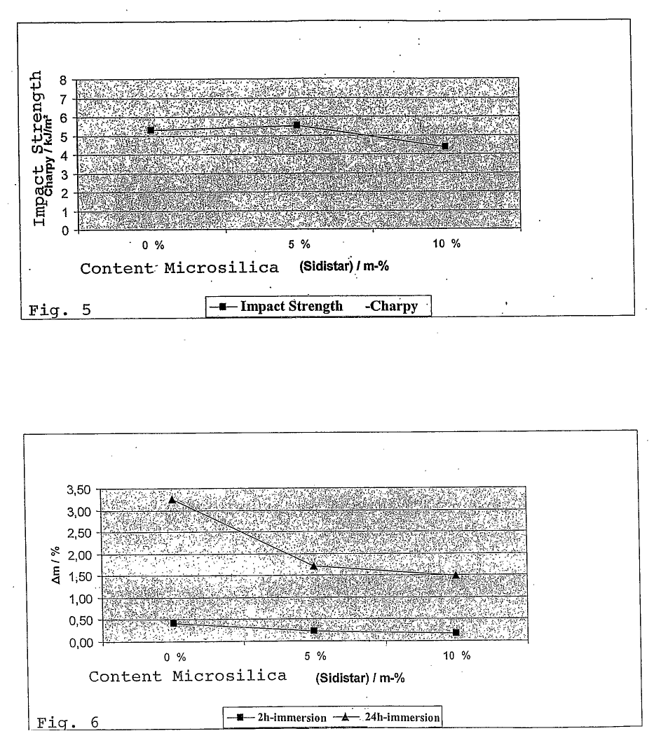

FIG. 6 is a graph similar to FIG. 5 showing water absorption;

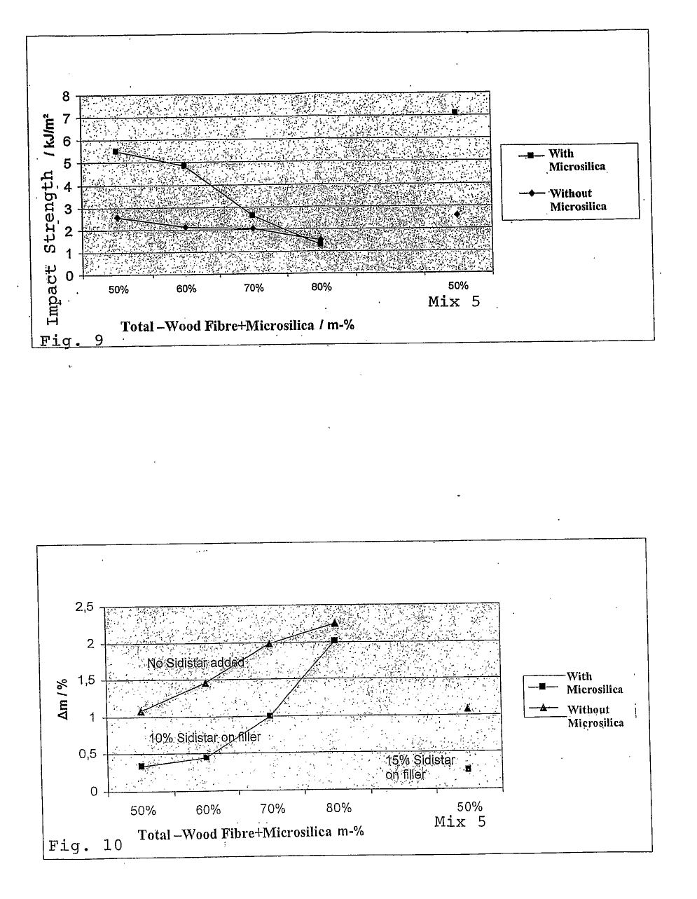

FIG. 7 is a graph showing the tensile modulus and tensile strength for composite material including PVC, both with an without microsilica;

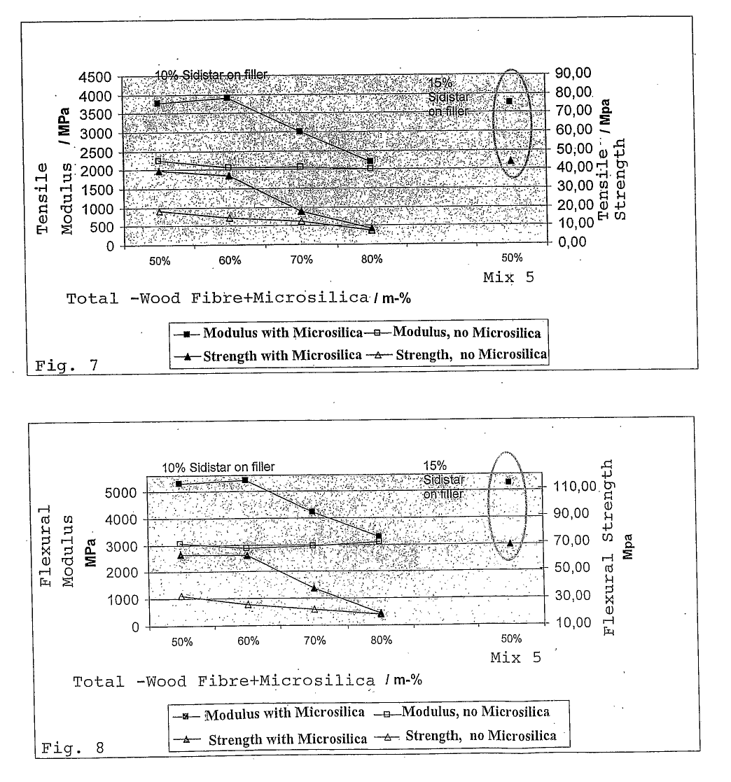

FIG. 8 is a graph similar to FIG. 7, showing the flexural modulus and flexural strength;

FIG. 9 is a graph showing Charpy impact strength for composite materials including PVC, both with and without microsilica; and

FIG. 10 is a graph similar to FIG. 9, showing water absorption.

FIG. 1 shows wood fibre filled HDPE, to a magnification of ×1200. The material comprises 60% wood fibres and 40% HDPE, by weight.

FIG. 2 shows wood fibre filled HDPE, to the same magnification, but with the addition of 10% microsilica in place of the polymer, giving a resultant 10% microsilica, 30% HDPE and 60% wood fibre combination, again by weight. The microsilica can be seen to be evenly dispersed in the wood fibre reinforced high density polyethylene (HDPE). It is important to note that good dispersion is essential to achieve the desired improvement in properties of the final product.

| | |
|---|---|
| | Impact |
| Impact | Strength |
| Energy [J] | [KJ/m²] |

| Sample No. | x̅ | s | x̅ | s |
|---|---|---|---|---|
| 701 | 0.47 | 0.02 | 5.31 | 0.25 |
| 702 | 0.48 | 0.04 | 5.52 | 0.42 |
| 703 | 0.38 | 0.02 | 4.35 | 0.20 |

As can be seen, these mechanical properties in Tables 3, 4 and 5 are no worse in the case of the samples with microsilica added, and in some instances, are improved.

Table 6 and 7 show properties relating to water absorption. In each case, samples were weighed, immersed in water, then removed and allowed to drain for 15 minutes. They were then re-weighed. The results in Table 6 correspond to 2 hours' immersion and the results in Table 7 relate to 24 hours' immersion.

The results are graphically represented in FIG. 6.

TABLE 6

| Sample No. | m₀ [g] | m_{2 h} [g] | Δm [g] | Δm [%] | Δm [%]/ x̅ |
|---|---|---|---|---|---|
| 701 | 4.0173 | 4.0336 | 0.016 | 0.4057 | 0.064 |
| | 3.9790 | 3.9952 | 0.016 | 0.4071 | |
| 702 | 3.9426 | 3.9511 | 0.008 | 0.2156 | 0.2196 |
| | 3.9358 | 3.9446 | 0.009 | 0.2236 | |
| 703 | 4.1199 | 4.1267 | 0.007 | 0.1651 | 0.1691 |
| | 4.1004 | 4.1075 | 0.007 | 0.1732 | |

TABLE 7

| Sample No. | m₀ [g] | m_{24 h} [g] | Δm [g] | Δm [%] | Δm [%]/ x̅ |
|---|---|---|---|---|---|
| 701 | 4.0173 | 4.1460 | 0.129 | 3.20 | 3.2492 |
| | 3.9790 | 4.1101 | 0.131 | 3.29 | |
| 702 | 3.9426 | 4.0144 | 0.072 | 1.82 | 1.7058 |
| | 3.9358 | 3.9984 | 0.063 | 1.59 | |
| 703 | 4.1199 | 4.1813 | 0.061 | 1.49 | 1.4902 |
| | 4.1004 | 4.1615 | 0.061 | 1.49 | |

As can be seen, the samples containing microsilica show significantly lower water absorption than the samples without microsilica, both after immersion for 2 hours, and 24 hours.

In Example 1, the test samples were lengths cut from extrusions having transverse dimensions of 134 mm (width) by 9 mm (thickness).

### EXAMPLE 2

### Addition of Amorphous Silica to Wood Fibre Reinforced PVC

Silica was added to a wood fibre reinforced PVC compound at different addition levels and compared to compounds containing only wood fibres (see Tables 8 and 9). The PVC compound includes a conventional lubricant/stabiliser system.

TABLE 8
Formulations of wood fibre reinforced PVC

| | |
|---|---|
| Control 1 | 50% PVC compound/50% wood fibres |
| Control 2 | 40% PVC compound/60% wood fibres |
| Control 3 | 30% PVC compound/70% wood fibres |
| Control 4 | 20% PVC compound/80% wood fibres |

TABLE 9
Formulations of wood fibre reinforced PVC with addition of silica

| | |
|---|---|
| Mix 1 | 50% PVC compound/45% wood fibres/5% silica |
| Mix 2 | 40% PVC compound/54% wood fibres/6% silica |
| Mix 3 | 30% PVC compound/63% wood fibres/7% silica |
| Mix 4 | 20% PVC compound/72% wood fibres/8% silica |
| Mix 5 | 50% PVC compound/42.5% wood fibres/7.5% silica |

The test results are summarised in the graphs of FIGS. 7 to 10.

In FIGS. 7 to 10, the numbers on the x-axis in each case represent the sum of wood fibre and microsilica content. It will be seen that in the case of Mixes 1-4, the ratio of wood fibre to microsilica remains constant at 9:1, i.e. the microsilica content of the mixture is a constant 10 wt %. In the case of Mix 5, the PVC compound content is 50 wt % but the wood fibre to microsilica ratio of the remaining 50 wt % is 17:3, i.e. the microsilica content of the wood fibre/microsilica mixture is increased to 15 wt %. Mix 5 values are shown separately at the extreme right of the Figures.

FIG. 7 shows the Tensile Modulus and Tensile Strength of the various formulations, Controls 1-4 and Mixes 1-5 in accordance with the invention.

FIG. 8 shows the Flexural Modulus and Flexural Strength of Controls 1-4 and Mixes 1-5.

FIG. 9 shows the Charpy impact strength of Controls 1-4 and Mixes 1-5.

FIG. 10 shows the water absorption of Controls 1-4 and Mixes 1-5, the samples having been immersed in water for 2 hours.

The tests carried out to determine the results shown in FIGS. 7 to 10 were conducted in the same way as the corresponding tests carried out in conjunction with HDPE described in Example 1.

It can be seen that all the compounds containing microsilica, up to a total concentration of 80% of the fibre/silica blend, are superior in the measured properties over those not containing microsilica. This means that compounds which contain only 20% of polymer are not only possible to produce, but also have excellent properties which are superior to the properties of known composite materials of this type.

It is also very likely that the fire suppressant effect of these composites which contain a lower amount of polymer and a certain amount of non-combustible mineral will be significantly better.

The combination of high modulus, high impact strength and significantly improved flame retardancy without using additional halogen or phosphorus containing flame-retardants. However, most importantly, the significantly reduced water absorption, provides a new range of material properties useful for the development of a wide variety of products, for instance for the automotive, construction and electrical industry.

1. A composition for making composite plastics material, comprising: a polymer, a natural organic filler and/or a natural organic fiber, and additionally, 5 to 20 wt % microsilica.

2. The composition as claimed in claim 1, in which the polymer is polyethylene (PE), polyvinylchloride (PVC), polypropylene (PP) or polyethylene terephthalate (PET).

3. The composition as claimed in claim 1, in which the natural filler is wood fiber or wood flour, wood flakes, sawdust, kenaf, flax, hemp or combinations of these.

4. The composition as claimed in claim 1, additionally comprising a non-organic filler.

5. The composition as claimed in claim 4, in which the non-organic filler is talc, calcium carbonate, wollastonite, aluminium trihydrate and combinations of these.

6. The composition as claimed in claim 1, in which the microsilica has specific density in the range 2.1 to 2.3 g/cm³.

7. The composition as claimed in claim 1, in which the microsilica has a specific surface area of 15 to 50 m²/g.

8. The composition as claimed in claim 1, in which the polymer represents from 10 to 60 wt % of the composition.

9. The composition as claimed in claim 1, in which the natural filler and/or natural fiber represents from 40 to 80 wt % of the composition.

10. (canceled)

11. A method of making a composite material comprising a step of heat-extruding a the composition as claimed in claim 1.

12. A method of making a composite material comprising
forming to shape the composition as claimed in claims 1, and
curing the polymer.
